(19) United States
(12) Patent Application Publication
(10) Pub. No.: US 2002/0072852 A1
(43) Pub. Date: Jun. 13, 2002

(54) Apparatus and method for using GPS aboard satellites

(76) Inventors: Stephen W. Fuchs, Victoria, MN (US); Andrew J. Wardrop, Lakeville, MN (US); Doyle G. Lahti, Northfield, MN (US)

Correspondence Address: JENNER & BLOCK, LLC, ONE IBM PLAZA, CHICAGO, IL, 60611, US

(21) Appl. No.: 09/945,487

(22) Filed: Aug. 30, 2001

Related U.S. Application Data
(60) Provisional application No. 60/230,282, filed on Sep. 1, 2000.

(51) Int. Cl. G01C 21/00; G01S 1/00

(52) U.S. Cl. 701/213; 342/357.02

(57) ABSTRACT

An apparatus and method for using GPS uses a radiation tolerant executive module to monitor and reinitialize a GPS module. The GPS module can reload information from a radiation tolerant memory when it is reinitialized. The radiation tolerant executive module also can direct a first GPS module having a first clock generator and a second GPS module having a second clock generator to use a clock signal from one of the first clock generator and the second clock generator. The radiation tolerant executive module also may be used to direct a first GPS module having a first clock generator and a second GPS module having a second clock generator to phase lock the first clock generator to the second clock generator.

### BACKGROUND OF THE INVENTION

1. Field of the Invention

The present invention relates to using Global Positioning System (“GPS”) components aboard satellites. More specifically, the present invention relates to an apparatus and method for using GPS aboard satellites in a fault tolerant manner.

2. Description of the Related Art

With the increasing demand for global communications as well as other global transfers of data, the usage of satellites continues to increase. With this increased satellite usage comes a need to precisely monitor the location and attitude of satellites. GPS has been used aboard satellites for making navigation and attitude determinations. Conventional GPS units used aboard satellites have been made radiation tolerant to withstand the cosmic radiation that may be encountered by the satellites. Such radiation tolerant GPS units typically consume more power and are more expensive than non-radiation tolerant GPS components. However, nonradiation tolerant GPS components have not previously been used aboard satellites because of the potential malfunctions that can result from exposure to radiation.

Therefore, it would be desirable to use aboard satellites non-radiation tolerant GPS components that can be re-set or reinitialized, as needed, when exposed to radiation.

### SUMMARY OF THE INVENTION

The present invention overcomes these and other limitations by using a radiation-tolerant executive module to monitor one or more GPS modules for malfunctions that can result from radiation exposure. When such a malfunction is detected, the executive module can reinitialize the affected GPS module(s) to restore normal operation. In addition, a GPS module used may include a radiation-tolerant memory. In this embodiment, the GPS module may reload software from its own radiation-tolerant memory, rather than reload software from the executive module, during reinitialization. The executive module also may be used to direct a first GPS module having a first clock generator and a second GPS module having a second clock generator to both use one of the first clock generator and the second clock generator. In addition, the executive module may be used to direct a first GPS module having a first clock generator and a second GPS module having a second clock generator to phase lock the first clock generator and the second clock generator.

### BRIEF DESCRIPTION OF THE DRAWINGS

FIG. 1 is a schematic diagram of two GPS Modules interfaced with one Executive Module;

FIG. 2 is a schematic diagram of a GPS Module; and

FIG. 3 is a schematic diagram of an Executive Module.

### DETAILED DESCRIPTION OF THE PREFERRED EMBODIMENT

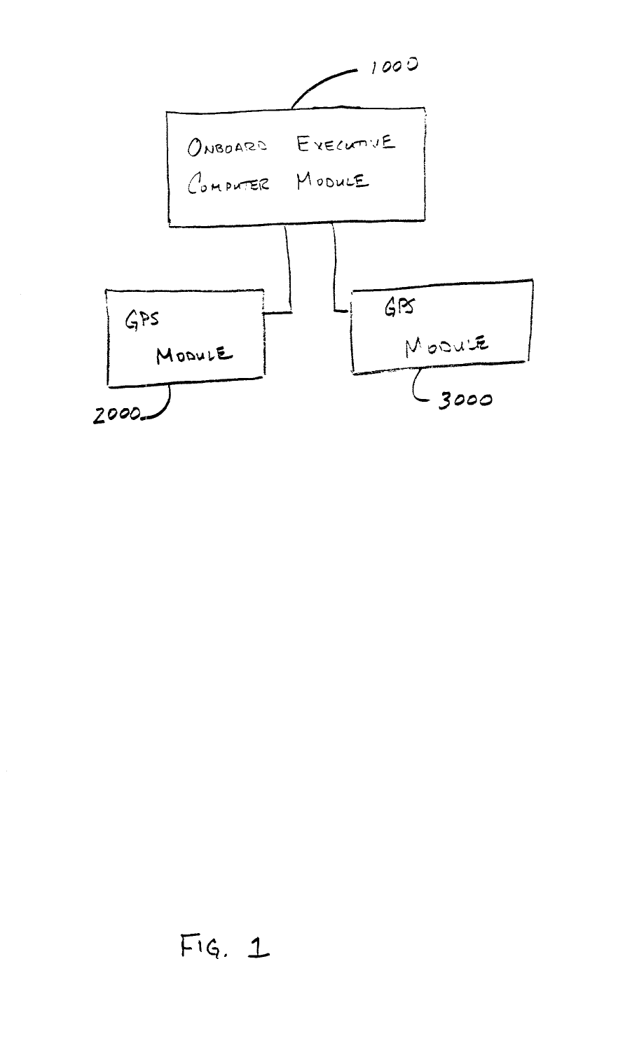

The present invention provides for fault tolerant satellite navigation and attitude determination using Global Positioning System (“GPS”) signals. FIG. 1 illustrates an Onboard Executive Computer Module (“Executive Module”) 1000 that is tolerant to Single Event Upsets (“SEU”) caused by ionizing radiation that can be encountered by satellites and other spacecraft that travel outside of the protective terrestrial atmosphere and magnetosphere of Earth. FIG. 1 further illustrates a first Global Positioning System Module (“GPS Module”) 2000 and a second GPS Module 3000, each of which typically receive and process GPS signals to enable Executive Module 1000 to make navigation and attitude determinations. While not depicted in FIG. 1, a second Onboard Executive Computer Module could be included in the present invention to provide redundancy in the event that the main Executive Module 1000 becomes inoperable.

1. The Global Positioning System (GPS) Modules

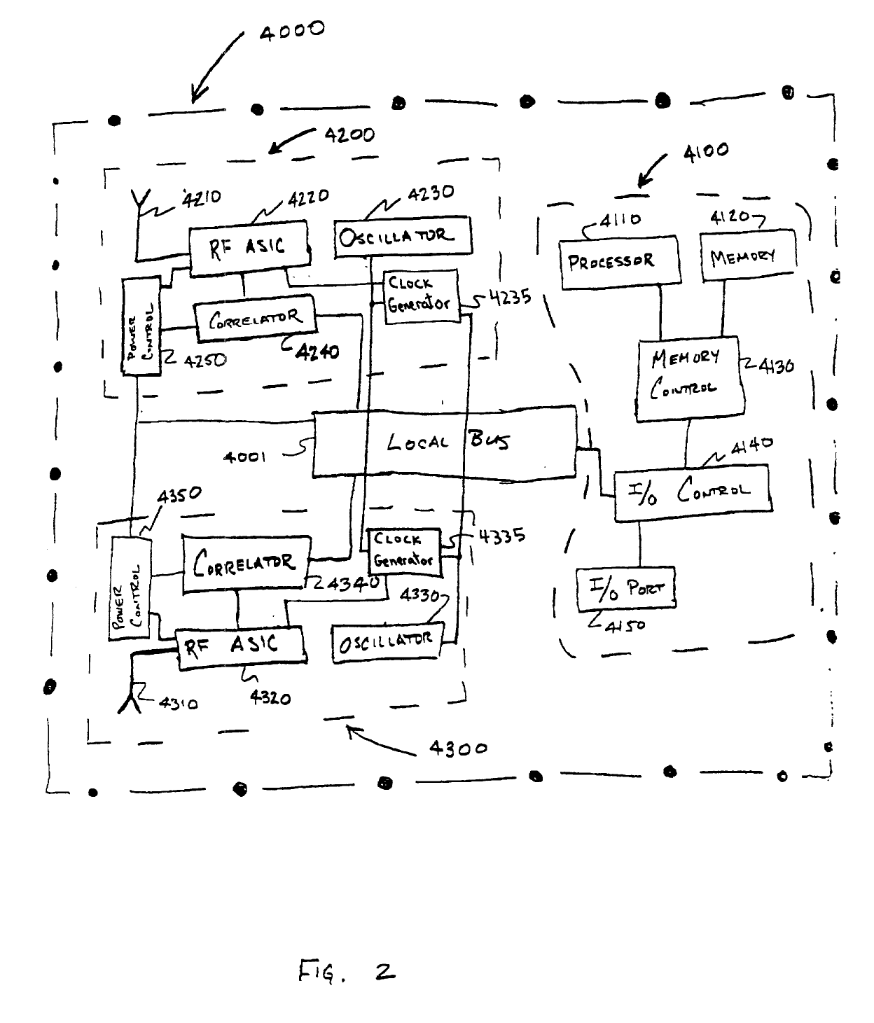

FIG. 2 illustrates a typical GPS Module 4000. GPS Module 4000 typically comprises a first RF Thread 4200, a second RF Thread 4300, a GPS Receiver Manager Module 4100, and a local bus 4001. The structures of both GPS Module 2000 and GPS Module 3000 (both shown in FIG. 1) typically are identical to the structure of GPS Module 4000. RF Thread 4200 typically comprises an antenna 4210, an RF ASIC 4220, an oscillator 4230, a correlator 4240, and a power control 4250. RF Thread 4300 is structurally identical to RF Thread 4200 and likewise typically comprises an antenna 4310, an RF ASIC 4320, an oscillator 4330, a correlator 4340, and a power control 4350. There are several commercial-off-the-shelf and proprietary GPS chip sets that may be used in RF Thread 4200 and RF Thread 4300. In a preferred embodiment of the present invention, a Mitel chipset is used. In this embodiment, Mitel GP2021 correlators may be used for correlator 4240 and correlator 4340. In addition, Mitel GP2015 RF front ends may be used for RF ASIC 4220 and RF ASIC 4320. Both RF Thread 4200 and RF Thread 4300 carry twelve (12) correlation channels, resulting in a total of twenty-four (24) correlation channels in GPS Module 4000. Accordingly, both GPS Module 2000 and GPS Module 3000 carry twenty-four (24) correlation channels. The components for this preferred embodiment of the RF Thread can be purchased from Mitel Semiconductor.

Components of the RF Threads 4200 and 4300 may have their power controlled individually or collectively. This serves two purposes: (1) to conserve power if only one RF Thread is desired for use; and (2) to correct certain radiation induced failure conditions in the RF Thread components known as “latchup” without having to cycle power to the other RF Thread or the entire GPS module.

When multiple GPS modules are used for attitude determination, current technology requires that they all have a common clock signal available in order to measure carrier phase differences between the various RF threads. This can be done by having a single clock generator 4235 or clock generator 4335, and distributing the clock output to the multiple GPS modules. Alternatively, and preferably, each GPS module can have its own internal clock generator 4235 and clock generator 4335 which can be phase locked to the clock(s) in any and every other GPS Module. In operation, the Executive Computer 1100 can designate a single clock signal for each GPS Module to use, so that all of the GPS Modules use the same clock signal. Each GPS Module can use the clock signal directly from the designated clock, or it can use the signal from an internal clock which is phase locked to the designated clock located in another module.

GPS Receiver Manager Module 4100 performs receiver management functions for RF Threads 4200 and RF Threads 4300. The receiver management functions of GPS Receiver Manager Module 4100 typically include monitoring the code tracking loop, carrier tracking loop, correlator detection threshold determination, correlator management, bit detection, bit sync and message frame sync. In addition, GPS Receiver Manager Module 4100 reduces the raw data received from RF Thread 4200 and RF Thread 4300 to sensor data in the form of pseudo ranges, which are then transmitted to Executive Computer 1100 for use in generating navigation and/or attitude data.

GPS Receiver Manager Module 4100 typically is comprised of a processor 4110, a memory 4120, and memory control 4130, an I/O control 4140, and an I/O port 4150. Any type of I/O port may be used for I/O port 4150. Such I/O ports that may be used include VME buses, PCI buses, 1553s, RS422, USARTs and UARTs. In one preferred embodiment of the present invention, a VME bus is used for I/O port 4150.

2. The Executive Module

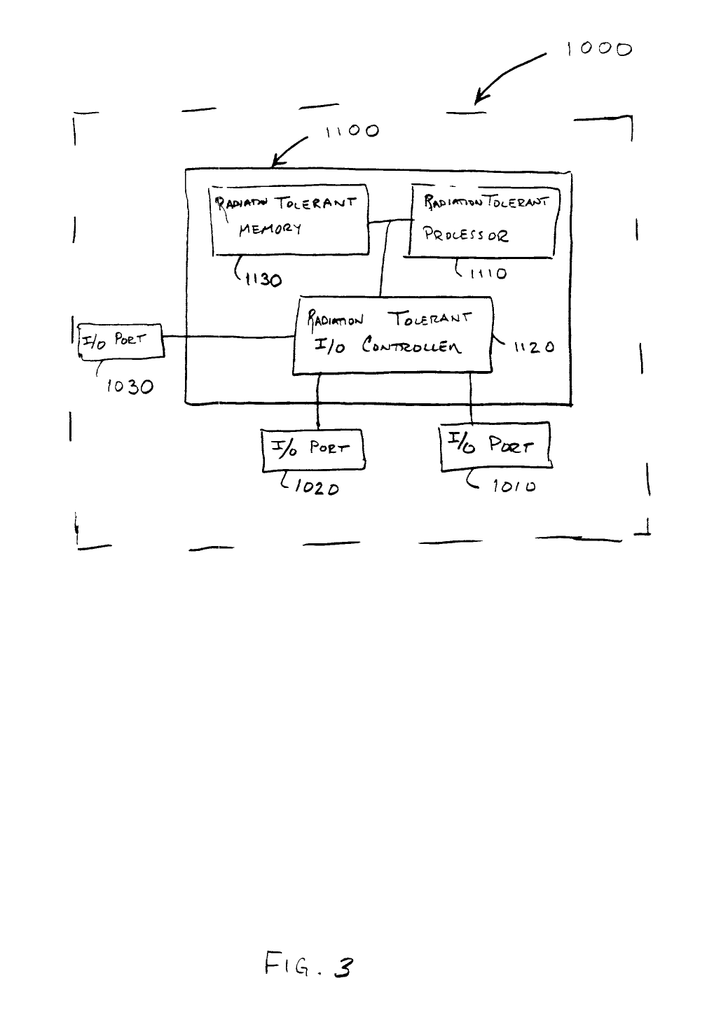

FIG. 3 illustrates a detailed schematic of Executive Module 1000. Executive Module 1000 performs navigation and attitude algorithms upon GPS data received from GPS Modules 2000 and 3000. Executive Module 1000 further monitors the GPS data received from GPS Modules 2000 and 3000 to detect when ionizing radiation has caused an SEU in either GPS Module 2000 or GPS Module 3000. When Executive Module 1000 detects a SEU in either GPS Module 2000 or GPS Module 3000, Executive Module 1000 will cause the GPS Module that was affected by the SEU to reinitialize.

Executive Module 1000 typically comprises an Executive Computer 1100 that is radiation tolerant to prevent ionizing radiation from causing a SEU and at least three Input/Output (“I/O”) ports 1010, 1020, and 1030.

Executive computer 1100 includes a radiation tolerant processor 1110, a radiation tolerant I/O controller 1120, and a radiation tolerant memory 1130. Radiation tolerant processors are available from manufactures such as Honeywell, Lockheed Martin, and General Dynamics. A preferred embodiment of the present invention uses a radiation tolerant Power PC 603e, which is available from General Dynamics.

Any type of I/O port may be used for I/O Port 1010, I/O Port 1020, and I/O Port 1030. Such I/O ports that may be used include VME buses, PCI buses, 1553s, RS422, USARTs, and UARTs. In one embodiment of the present invention, VME buses are used for I/O Port 1010 and I/O Port 1020.

Executive Computer 1100 first converts the GPS pseudoranges transmitted from GPS Modules 2000 and 3000 into positional data. Executive Processor 1110 then performs a Receiver Autonomous Integrity Monitoring (“RAIM”) algorithm upon the positional data to detect any pseudorange outliers. The use of pseudorange outliers is prevented when Executive Computer 1100 performs an algorithm upon the positional data to generate navigational and/or attitude data, depending upon the type of data needed.

The presence of pseudorange outliers in the pseudorange data transmitted from GPS Modules 2000 and 3000 indicates that the data may have been corrupted by a “bit flip” when GPS Modules 2000 and 3000 encountered ionizing radiation. If Executive Computer 1100 detects pseudorange outliers in the data received from either GPS Module 2000 or GPS Module 3000, Executive Computer 1100 will cause the GPS Module that transmitted the data containing the outlier to re-initialize. As part of reinitializing, the GPS Module that transmitted the pseudorange outlier will reload its software. In a preferred embodiment, the GPS Module would reload the software from its own radiation tolerant memory 4120. If the GPS Module does not have radiation tolerant memory, the GPS module can reload the software from the radiation tolerant memory 1130 of the Executive Computer 1100.

After Executive Computer 1110 has determined that the pseudoranges are valid, Executive Processor 1110 performs algorithms upon the data to determine navigational values such as position and velocity. It should be noted that only one of GPS Module 2000 and GPS Module 3000 is required to generate these navigational values. Also, only one RF Thread 4200, 4300 on one of GPS Module 2000 and GPS Module 3000 is required to calculate these navigational values. Consequently, while a preferred embodiment of the invention incorporates GPS Module 2000 and GPS Module 3000, navigational data may be generated according to the present invention using only one of GPS Module 2000 and GPS Module 3000. Although this embodiment is not shown, referring to FIG. 1, this embodiment could comprise, for example, only Executive Processor 1000 and GPS Module 2000.

Executive Computer 1100 may also perform an algorithm upon the carrier phase data to determine attitude, or the angle at which the instruments of a satellite or other spacecraft make with an object of interest, typically the Earth. Both GPS Module 2000 and GPS Module 3000 must be operational for Executive Computer 1100 to generate attitude data. However, only three of the four RF Threads comprising GPS Module 2000 and GPS Module 3000 (each of these GPS modules including two RF Threads) are necessary to generate attitude data from the carrier phase data. Software to perform the navigational and attitude algorithms upon the GPS module data is available from L-3 Communications, Conic Division, 9020 Balboa Avenue, San Diego, Calif. 92133, as well as other sources.

Executive Computer 1100 exchanges data with GPS Module 2000 via I/O Port 1020 and with GPS Module 3000 via I/O Port 1010. Executive Computer 1100 may further exchange data with additional componentry that this invention is incorporated into via I/O Port 1030. Additional, simultaneously active GPS Modules can improve the ability to determine which GPS Module has been corrupted, and to provide position, velocity, and attitude values while corrupted GPS Modules are being reinitialized. Two or more GPS Modules can provide continuous position and velocity values, even while one is corrupted and/or is being reinitialized, and three or more GPS Modules can provide continuous attitude values even while one is corrupted and/or is being reinitialized. In these cases, Executive Computer 1100 would determine which of the several GPS Modules does not agree with the others, cause the faulty GPS Module to be reinitialized, and use the values from the other, correctly functioning GPS Modules as the correct values.

In an alternate embodiment, the functions of converting pseudoranges to position and velocity values can be performed by GPS Receiver Manager Module 4100, instead of Executive Computer 1000. GPS Receiver Manager Module 4100 can perform this conversion separately for the two RF threads in the GPS Module. Radiation-induced upsets in an RF thread or a GPS Receiver Manager Module 4100, while it is processing the data from a single RF thread, should corrupt only a single set of position and velocity values. The radiation-tolerant Executive Computer 1100 compares the position and velocity values from the two RF threads, and determines if they are within an appropriate error tolerance. If the two sets of values do not agree, then one or both sets is deemed corrupted, and the executive processor will cause the applicable GPS Module to be reinitialized.

In this embodiment the executive processor has less to do, and can therefore be smaller and less expensive. Preferably, the executive processor is embedded in a radiation-tolerant support ASIC. It may be physically co-located with the GPS module, although logically separate as shown in FIG. 1.

To perform attitude determination with this alternative embodiment, two or more GPS Modules are needed. These GPS Modules would exchange carrier phase information, using any appropriate data transfer means, and would separately perform an attitude determination calculation. The attitude values would be sent to the executive processor, which would compare the two sets of values. If they did not agree within an appropriate error tolerance, both GPS Modules would be reinitialized. However, if it was otherwise obvious, for example, based on the position and velocity values, which of the GPS Modules was in error, then only the errant GPS Module would be reinitialized.

Certain data that is critical to the pseudorange-to-position determination process, such as the orbital parameters of the GPS satellite constellation, may be stored in radiation tolerant memory in either the GPS Module or Executive Computer 1100. This information can be used during GPS Module reinitialization to allow the GPS Module to initialize much more rapidly, since the information otherwise must be obtained from the signals from GPS satellites.

Whereas the present invention has been described with respect to specific embodiments thereof, it will be understood that various changes and modifications will be suggested to one skilled in the art and it is intended that the invention encompass such changes and modifications as fall within the scope of the appended claims.

We claim:

1. An apparatus for using GPS, comprising:
a GPS module;
an executive module that is adapted to be radiation tolerant and to selectively monitor said GPS module; and
wherein said GPS module is adapted to be reinitialized by said executive module.

2. The apparatus as recited in claim 1, wherein:
said GPS module has a radiation tolerant memory; and
said GPS module is adapted to reload information from said radiation tolerant memory when said GPS module is reinitialized by said executive module.

3. An apparatus for using GPS, comprising:
a GPS module that is adapted to generate position and velocity data;
an executive module that is adapted to be radiation tolerant and to selectively monitor the position and velocity data generated by said GPS module; and
wherein said GPS module is adapted to be reinitialized by said executive module.

4. The apparatus as recited in claim 3, wherein:
said GPS module has a radiation tolerant memory; and
said GPS module is adapted to reload information from said radiation tolerant memory when said GPS module is reinitialized by said executive module.

5. An apparatus for using GPS, comprising:
a first GPS module having a first clock generator;
a second GPS module having a second clock generator;
an executive module that is adapted to be radiation tolerant, to selectively monitor said first GPS module and said second GPS module, and to direct both of said first GPS module and said second GPS module to use one of said first clock generator and said second clock generator; and wherein
said first GPS module is adapted to be directed by said executive module to use one of said first clock generator and said second clock generator, and
said second GPS module is adapted to be directed by said executive module to use one of said first clock generator and said second clock generator.

6. The apparatus as recited in claim 5, wherein:
said first GPS module is adapted to be reinitialized by said executive module.

7. The apparatus as recited in claim 6, wherein:
said first GPS module has a radiation tolerant memory; and
said first GPS module is adapted to reload information from said radiation tolerant memory when said first GPS module is reinitialized by said executive module.

8. The apparatus as recited in claim 5, wherein:
said second GPS module is adapted to be reinitialized by said executive module.

9. The apparatus as recited in claim 8, wherein:
said second GPS module has a radiation tolerant memory; and
said second GPS module is adapted to reload information from said radiation tolerant memory when said second GPS module is reinitialized by said executive module.

10. A method for using GPS, comprising the steps of:
using an executive module adapted to be radiation tolerant to selectively monitor a GPS module; and
reinitializing the GPS module with the executive module when a malfunction is detected in the GPS module.

11. The method as recited in claim 10, further comprising the step of:
reloading information from a radiation tolerant memory in the GPS module.

12. A method for using GPS, comprising the steps of:
using a GPS module to generate position and velocity data;
using an executive module that is radiation tolerant to selectively monitor the position and velocity data; and
using the executive module to reinitialize the GPS module when a malfunction is detected.

13. The method as recited in claim 12, further comprising the step of:
reloading information from a radiation tolerant memory in the GPS module.

14. A method for using GPS, comprising the steps of:
using a first GPS module having a first clock generator;
using a second GPS module having a second clock generator;
using an executive module adapted to be radiation tolerant to selectively monitor the first GPS module and the second GPS module;
using the executive module to direct both of the first GPS module and the second GPS module to use one of the first clock generator and the second clock generator.

15. The method as recited in claim 14, further comprising the step of:
using the executive module to reinitialize the first GPS module when a malfunction is detected.

16. The method as recited in claim 15, further comprising the step of:
reloading information from a radiation tolerant memory in the first GPS module.

17. The method as recited in claim 15, further comprising the step of:
using the executive module to reinitialize the second GPS module when a malfunction is detected.

18. The method as recited in claim 17, further comprising the step of:
reloading information from a radiation tolerant memory in the second GPS module.
